(19) United States
(12) Patent Application Publication
(10) Pub. No.: US 2017/0125010 A1
(43) Pub. Date: May 4, 2017

(54) Method and system for controlling voice entrance to user ears, by designated system of earphone controlled by Smartphone with reversed voice recognition control system

(71) Applicant: Yaniv Herman, Lod (IL)

(72) Inventor: Yaniv Herman, Lod (IL)

(21) Appl. No.: 14/926,964

(22) Filed: Oct. 29, 2015

(51) Int. Cl. G10L 15/00

(52) U.S. Cl. CPC G10L 15/00

(57) ABSTRACT

Method and system for controlling voice entrance to user ears, by designated system of earphone controlled by Smartphone with reversed voice recognition control system, wherein, a Voice Recognition (VR) system distinction between some environmental voices and between some human participates, optionally in a telephones call. Wherein, such distinctions, enabled by voice recognition dedicated software's and a Smartphone device. Wherein, dedicated software's in Smartphone device enable the user, a visual display in his Smartphone screen, including a Voice Recognition (VR) system enabling the user to control the voices, by approving some of the voice and blocking some other voices, wherein, the voices approved by the user, are the voice that passes to the user earphone connected to the Smartphone. Wherein, optionally some of the functions of the present system and software's are at the earphone device.

### BACKGROUND OF THE INVENTION

Hearing deficiencies can range from partial to complete hearing loss. Often, an individual's hearing ability varies across the range of audible sound frequencies, and many individuals have hearing impairment with respect to only some acoustic frequencies. For example, an individual's hearing loss may be greater at higher frequencies than at lower frequencies.

Hearing aids have been developed to compensate for hearing losses in individuals. Conventionally, hearing aids range from ear pieces configured to amplify sounds to configurable hearing devices offering adjustable operational parameters that can be configured by a hearing specialist to enhance the performance of the hearing aid. Parameters, such as volume or tone, often can be adjusted, and many hearing aids allow for the individual users to adjust these parameters.

However, such hearing aids generally do not permit the user to adjust other parameters or response characteristics, including signal amplitude and gain characteristics, and parameters associated with signal processing algorithms, including signal frequency transforms. Instead, a hearing health professional can adjust the hearing aid, by taking measurements using calibrated and specialized equipment to assess an individual's hearing capabilities in a variety of sound environments, and then by adjusting the hearing aid based on the calibrated measurements. Subsequent adjustments, other than adjustments to volume or tone, can require a second visit to and further calibration by the hearing health professional, which visit can be costly and time intensive.

In some instances, the hearing health professional may create multiple hearing profiles for the user for use in different sound environments. Such hearing profiles represent a combination of a sound-shaping algorithms and associated coefficients for providing a customized audio compensation for the user.

Unfortunately, merely providing multiple stored hearing profiles to the user may be insufficient to provide a satisfactory hearing experience. In particular, the limited number of such hearing aid profiles may not take into account the variety of acoustic frequencies and amplitudes of a particular acoustic environment of the user. Thus, in some instances, it is possible that none of the various stored hearing aid profiles will accurately reflects the user's actual acoustic environment. Alternatively, even if an appropriate profile is available, the user may not know that a more suitable hearing aid profile is available for the particular acoustic environment and/or the user may make a less than ideal selection by choosing the wrong hearing aid profile for the particular acoustic environment.

However, these are the problems that people suffering from hearing problems, but, hearing difficulties are existing in every person man and female in the world, difficulties from background noise, or background noise while making a telephone conversation, wherein, the present invention enable a noise-filtering features by the method and system of the present invention, enables the user of the present invention devices and system, the following:

A. To control voices from his surrounding environment, by putting his earphone, and controlling the entering of the voices;

B. And/or to controlled voices when operating a telephone call conversation, voices coming from the environment of another participant in the conversation of a telephone call, enables to Eliminates Environmental Voice (EEV), or any selected voice that is recognized by the system.

### SUMMARY OF THE INVENTION

Method and system for controlling voice entrance to user ears, by designated system of earphone controlled by Smartphone with reversed voice recognition control system.

Wherein, a Voice Recognition (VR) system distinction between some environmental voice and between some human participates in a telephones call. Wherein, such distinctions, enabled by voice recognition dedicated software's and a Smartphone device. Wherein, dedicated software's in a Smartphone device enable the user, a visual display in his Smartphone screen, including a Voice Recognition (VR) system enabling the user to control the voices, by approving some of the voice and blocking some other voices, wherein, the voices approved by the user, are the voice that passes to the user earphone connected to the Smartphone.

Wherein, optionally some of the functions of the present system and software's are at the earphone device.

Wherein, the method and system enables a noise-filtering features by the method and system of the present invention, enables the user of the present invention, as follows:

A. To control voices from his surrounding environment, by putting his earphone, and controlling the entrance of some voices;

B. And/or to controllers some voices when operating a telephone call conversation, voices coming from the environment of another participant in the conversation of a telephone call, enables to Eliminates Environmental Voice (EEV), or any selected voice that is recognized by the system.

### DESCRIPTION OF THE PREFERRED EMBODIMENTS

The descriptions of this appendix, are included in this present patent request with the objective of providing a greater understanding of the invention, and are included and form part of this patent. The description herein, provide more detailed description of different embodiments of the invention, and together with the other parts of the patent application documents, serve the purpose of explaining the principles and the method of operation of the invention; all this only by way of example, and not with the objective of limiting the invention to these descriptions exclusively.

The present invention enables method and system for earphone, designated for filtering and controlling and selecting part of the voices which the user want to allows to entre to his ears, by designated system of earphone controlled by Smartphone system, with an application of dedicated software's that enables to apply a Reversed Voice Recognition, and a control panel screen system.

Wherein, the Reversed Voice Recognition (RVR) is an a software application, that accept all entering voices, identifying and separates such voices to their different sources, to human sources, and other sources, and furthermore, separates these human voices to their individuals, and enable a Smartphone screen exhibitions, enabling the user to select these voices to be filtered, and allowing other voices to pass.

Wherein, the Reversed Voice Recognition software application, connected to a hardware that have database information, enable to recognize human voice and between human voices, by their different Frequency, and Frequency behaviours.

Wherein, the “Reversed” in the (RVR) refers to: the scanning of the Recognition software that searching correlations between the database information in the hardware, and between the real-time organizing of the voices to different sources.

Wherein, like the above mentioned, a Voice Recognition (VR) system enable to distinction between some environmental voice and between some human voices participates in some telephones call.

Wherein, such distinctions, enabled by voice recognition dedicated software's and a Smartphone device. Wherein, dedicated software's in a Smartphone device enable the user, a visual display in his Smartphone screen, including a Voice Recognition (VR) system enabling the user to control the voices, by approving some of the voices and blocking some other voices, wherein, the voices approved by the user, are the voices that passes to the user earphone connected to the Smartphone.

Wherein, optionally some of the functions of the present system and software's are at the earphone device.

Wherein, the method and system enables “a noise-filtering features” by the method and system of the present invention, enables the user controlling and operating the present invention devices and system, as following:

A. Enable to control voices from his surrounding environment, by putting his earphone, and controlling the entering of such type of voices;

B. And/or to controlled voices when operating a telephone call conversation, voices coming from the environment of another participant in the conversation of a telephone call, enables to Eliminates Environmental Voice (EEV), or any selected voice that is recognized by the system.

This present invention does not intend to be limited to embodiments described above, but to include all embodiments in the range of the following claims.

1. Method for controlling voice entrance to user ears, by designated system of earphone controlled by Smartphone with a reversed voice recognition software's application control system, as follows:
A. A Voice Recognition (VR) system has a database information that enable it to distinction between some environmental voice and between some human voice; wherein,
B. Distinctions between individuals with human voice that participate in a telephones call for example, enabled by voice recognition dedicated software's and a Smartphone device, wherein,
C. Dedicated software's in a Smartphone device enable the user a visual display in his Smartphone screen, including a Voice Recognition (VR) system enabling the user to control the voices, by approving some of the voice and blocking some other voices; wherein,
D. The voices approved by the user, are the voice that passes to the user earphone connected to the Smartphone; wherein, optionally,
E. Some of the functions of the present system and software's are at the earphone device; wherein,
F. The system enables a voices-filtering features, enables the user of the present invention using the devices and system, the following:
a. To control voices from his surrounding environment, by putting the earphone on his ears, and controlling the entering or blocking such voices;
b. And/or to controlled voices when operating a telephone call conversation, voices coming from the environment of another participant in the conversation of a telephone call, and/or enables to Eliminates Environmental Voice (EEV), or any selected voice that is recognized and identified by the system.
